(19) United States
(12) Patent Application Publication
(10) Pub. No.: US 2014/0375840 A1
(43) Pub. Date: Dec. 25, 2014

(54) IMAGE-CATCHING DEVICE AND METHOD FOR CATCHING IMAGE AND EXPORTING IMAGE STREAM

(71) Applicant: ABILITY ENTERPRISE CO., LTD., New Taipei City (TW)

(72) Inventor: Ping-Yuan HSIEH, New Taipei City (TW)

(73) Assignee: ABILITY ENTERPRISE CO., LTD., New Taipei City (TW)

(21) Appl. No.: 14/300,371

(22) Filed: Jun. 10, 2014

(30) Foreign Application Priority Data
Jun. 21, 2013 (TW) 102122154

(51) Int. Cl. H04N 5/91

(52) U.S. Cl. CPC H04N 5/91
USPC 348/231.99

(57) ABSTRACT

An image-catching device is provided. The image-catching device includes a sensor exporting a first image data or a second image data, and a control module. The control module asks the image-catching device to send the first image data to an external device when the image-catching device and the external device are connected. The control module asks the sensor to output the second image data when the image-catching device and the external device are disconnected. The first and the second image data respectively include a plurality of frames. Each frame of the first image data has A pixels, while each frame of the second image data has B pixels, and A is greater than B.

This application claims the benefit of Taiwan application Serial No. 102122154, filed Jun. 21, 2013, the disclosure of which is incorporated by reference herein in its entirety.

### BACKGROUND

1. Technical Field

The disclosure relates in general to an image-catching device and a method for exporting image stream, and more particularly to an image-catching device capable of exporting image streams and a method for exporting image stream of the image-catching device.

2. Description of the Related Art

Generally, digital cameras are often used to watch or view the current scene. The conventional digital cameras can only export frames having fixed amounts of pixels and fixed speed when providing an image stream.

However, since the conventional digital cameras can only export frames having fixed amounts of pixels, and provided frames remain the same rate, users can not get better image quality when transmitting images to another device by streaming.

### SUMMARY

The disclosure is directed to an image-catching device and a method for exporting image stream, which could provide better image stream quality when transmitting images to another device.

According to one embodiment, an image-catching device is provided. The image-catching device includes a sensor exporting a first image data or a second image data, and a control module. The control module makes the image-catching device to send the first image data to an external device when the image-catching device connects to the external device. The control module makes the sensor to output the second image data when the image-catching device disconnects to the external device. The first and the second image data respectively include a plurality of frames. Each frame of the first image data has A pixels, while each frame of the second image data has B pixels, and A is greater than B.

According to another embodiment, an image-catching device is provided. The image-catching device includes a sensor exporting a first image data, and a control module. The control module makes the image-catching device to export the first image data to an external device when the image-catching device connects to the external device. The control module makes the sensor to terminate exporting the first image data when the image-catching device disconnects to the external device.

According to an alternative embodiment, an image-catching device is provided. The image-catching device includes a lens and a sensor sensing a plurality of beams passed through the lens and converting the beams to a first image data or a second image data. The first image data is provided with an external device when the image-catching device connects to the external device. The second image data is exported when the image-catching device disconnects to the external device. A pixel amount of a frame of the first image data is greater than a pixel amount of a frame of the second image data.

According to one embodiment, a method of exporting an image stream for an image-catching device including a sensor and a control module is provided. The method includes the following steps. The sensor exports a second image data when the image-catching device enters an image-stream-exporting mode. The control module determines whether the image-catching device connects to an external device, and makes the sensor to export a first image data to the external device when the image-catching device connects to the external device. A pixel amount of a frame of the first image data is greater than a pixel amount of a frame of the second image data.

According to another embodiment, a method of exporting an image stream for an image-catching device comprising a sensor and a control module is provided. The method includes the following steps. The control module determines whether the image-catching device connects to an external device when the image-catching device enters an image-stream-exporting mode. The sensor provides a first image data for the external device when the image-catching device connects to the external device. The sensor provides a second image data when the image-catching device disconnects to the external device. A frame of the first image data includes A pixels, a frame of the second image data includes B pixels, and B is not greater than A.

### BRIEF DESCRIPTION OF THE DRAWINGS

FIG. 1 illustrates an image-catching device according to one embodiment of the disclosure.

FIG. 2 shows a block diagram illustrating a method for exporting image stream of the image-catching device according to one embodiment of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

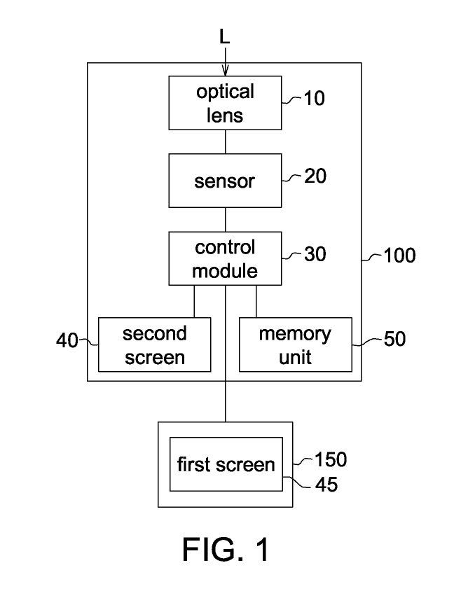

FIG. 1 illustrates an image-catching device according to one embodiment of the disclosure. The image-catching device includes a lens 10, a sensor 20 and a control module 30. Beams L from a target object are converged by the lens 10 for forming an image on the sensor 20. The sensor 20 senses the beams L and converts the beams L to a first image data or a second image data. The control module 30 asks the sensor to export the first image data or output the second image data, and then reads and computes the first image data or the second image data. The sensor 20 could be a Charge Coupled Device (CCD) or a Complementary Metal-Oxide Semiconductor (CMOS). The control module 30 could be an Application-Specific Integrated Circuit (ASIC), a Central Processing Unit (CPU) or a Digital Signal Processing (DSP).

In one embodiment, the sensor 20 could export the first image data to an external device 150 directly when the image-catching device 100 and the external device 150 are connected. In another embodiment, the sensor 20 could output the first image data to the control module 30, the control module 30 could compute the first image data, and then send the computed first image data to the external device 150. When the image-catching device 100 and the external device 150 are disconnected, that is, before the image-catching device 100 and the external device 150 are connected or after cutting of the connection between the image-catching device 100 and the external device 150, the sensor 20 outputs the second image data. Besides, the image-catching device 100 could include a memory unit 50. The memory unit 50 saves various image data outputted from the sensor 20, or saves the image data outputted from the sensor 20 to the control module 30 and then computed by the control module 30.

In one embodiment, the external device 150 could include a first screen 45 for displaying the first image data. After receiving the first image data, the external device 150 could display the first image data by the first screen.

In another embodiment, the image-catching device 100 could include a second screen 40. The sensor 20 outputs the second image data when the image-catching device 100 and the external device 150 are disconnected. At this time, the second image data could be sent to the second screen 40 directly, or be computed by the control module 30, and then be sent to the second screen 40. That is, the control module 30 could ask the sensor 20 to output the second image data to the second screen 40 after the image-catching device 100 and the external device 150 are disconnected.

Specifically, the first image data and the second image data respectively include a plurality of continuous frames to form an image stream. Each frame of the first image data includes A pixels, each frame of the second image data includes B pixels, and A is greater than B. That is, a pixel amount of each frame of the first image data is greater than a pixel amount of each frame of the second image data. Further, a frame rate of the frame of the first image forming the image stream could also be greater than a frame rate of the frame of the second image forming the image stream. For example, the first image data could have 1.33 M (1332×1000) pixels and the exporting speed of the first image data could be 119.88 frames/s, while the second image data could have 440K (1332×332) pixels and the outputting speed of the first image data could be 29.97 frames/s.

However, this disclosure does not limit thereto. The first image data could pre-set the amount of the pixels, the image resolution, and other parameters according to the size, the image resolution of the first screen 45, and other parameters of a suitable external device 150, and build these parameters in the image-catching device 100. Similarly, the amount of the pixels and the frame rate of the second image data could be pre-set according to the efficacy of the hardware and firmware of the image-catching device 100. Further, a pixel amount of the first image data is greater than a pixel amount of the second image data, and a frame rate of the second image data is greater than the a frame rate of the first image data in one embodiment. Besides, the external device 150 includes, but not limits to, a computer, a television or a portable mobile device, and the image-catching device 100 could exclude the second screen 40.

For example, in another embodiment, the image-catching device 100 could export the first image data to the external device 150 when the image-catching device 100 and the external device 150 are connected; the sensor 20 could terminate outputting the first image data when the image-catching device 100 and the external device 150 are disconnected. Here, the image-catching device 100 could be without the second screen 40, or the second screen 40 has not been activated (or the second screen 40 is off), such that the sensor 20 could terminate exporting the first image data when the image-catching device 100 and the external device 150 are disconnected.

In still another embodiment, the sensor 20 could keep outputting the second image data when the sensor does not export the first image data. Here, the second screen 40 could be built in the image-catching device 100, and it could be determined by the control module 30 whether the image-catching device sends the first image data, and whether the sensor 20 terminates exporting the first image data or starts outputting the second image data.

Further, in one embodiment, the image-catching device 100 and the external device 150 could be connected via a wire, a wireless or an Internet transmission technique, such that the first image data could be exported from the image-catching device 100 to the external device 150. Here, the way for sending the image data is through, for example, a wire transmission or a wireless transmission. Specifically, the wire transmission could use High-Definition Multimedia Interface (HDMI) or Universal Serial Bus (USB); the wireless transmission could use Wireless Fidelity (Wi-Fi), Near Field Communication (NFC) or Bluetooth. However, the wire transmission and the wireless transmission are not limited therein.

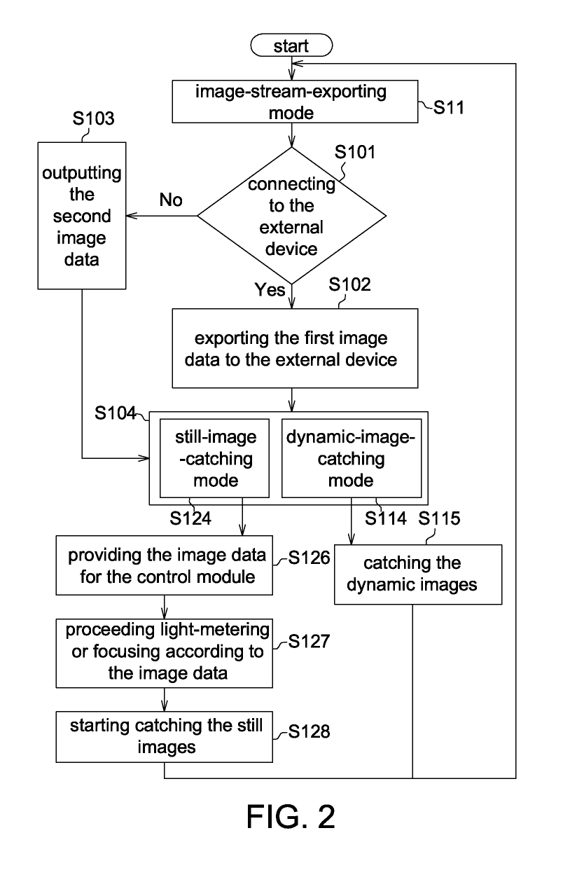

FIG. 2 shows a block diagram illustrating a method of catching an image for an image-catching device 100 according to one embodiment of the disclosure. In FIGS. 1 and 2, the following describes how each element of the image-catching 100 works in detail by the block diagram. However, the block diagram shown in FIG. 2 does not limit to the image-catching device 100 in FIG. 1, and the image-catching device 100 does not limit to follow the steps in FIG. 2.

In step S11, the image-catching device 100 enters an image-stream-exporting mode.

In step S101, the control module 30 determines whether the image-catching device 100 connects to the external device 150. If so, step S102 is executed; if not, step S103 is executed.

In step S102, the first image data exported from the sensor 20 is sent to the external device 150. Then, step S104 is executed.

In step S103, the sensor 20 outputs the second image data. Here, the second image data outputted from the sensor 20 could be sent to the control module 30, proceeded signal processing, and sent to the second screen 40. Then, step S104 is executed.

In step S104, the image-catching device 100 is in a dynamic-image-catching mode when receiving an instruction of video recording (that is, step S114), or in a still-image-catching mode when receiving an instruction of image catching (that is, step S124). When the image-catching device 100 is in the dynamic-image-catching mode, step S115 is executed; when the image-catching device 100 is in the still-image-catching mode, step S126 is executed. Specifically, the image-catching device 100 could be in the still-image-catching mode and the dynamic-image-catching mode according to the setting mode.

In step S115, after the user presses the execution button, the dynamic-image-catching mode is executed. At this time, the image-catching device 100 captures dynamic images from the sensor 20. In one embodiment, the sensor 20 outputs a third image data to the control module 30. Here, a pixel amount and a frame rate of the third image data could be the same as those of the first image data or the second image data. However, the pixel amount and the frame rate of the third image data could also be different from those of the first image data or the second image data. For example, the third image data could have 640×480 pixels (standard-definition, SD mode) or 1280×720 pixels (high-definition, HD mode). Besides, the sensor 20 could output the third image data directly, or proceed signal processing by the control module 30 and output the proceeded third image data. After the image-catching device 100 completes the dynamic images capturing, returning back to the image-stream-exporting mode in Step S11.

In step S126, the second image data could be provided for the control module 30 by the sensor 20. It should be noted that if the order to enter step S127 follows S103, S124, S126, S127, then the sensor 20 outputs the second image data; if the order to enter step S127 follows S102, S124, S126, S127, then the sensor 20 exports the first image data, and at this time, the sensor 20 could change exporting first image data to outputting the second image date in advance. Then, step S127 could be executed.

In step S127, following the instruction of the user, the control module 30 proceeds light-metering or focusing according to the second image data.

In one embodiment, the lens 10 could do a focus process in accordance with the second image data. In one more embodiment, the sensor 20 also could proceed light-metering in accordance with the second image data.

Then, in step S128, once the user instructs capturing image, the still-image-catching mode is executed, and the image-catching device 100 captures still images according to the result of the light-metering and focusing. After the image-catching device 100 completes the still images capturing, returning back to the image-stream-exporting mode in Step S11.

Besides, in another embodiment, the method of catching an image for an image-catching device 100 could include determining whether the second screen 40 is built in the image-catching device 100 in advance, and then determining whether the image-catching device 100 connects to the external device 150 (step S101). For example, when the image-catching device 100 and the external device 150 are disconnected and the second screen 40 is built in the image-catching device 100, step S103 is executed and the sensor 20 provides the second image data for the second screen 40. In addition, when the image-catching device 100 and the external device 150 are disconnected and the second screen 40 is not built in the image-catching device 100 or the second screen 40 has not been activated, the sensor 20 stops exporting the first image data and the second image data.

Further, in another embodiment, when the image-catching device 100 receives the instruction of catching still images in step S104, the image-catching device 100 is in the still-image-catching mode, and then step S126 is executed. Here, the sensor 20 keeps outputting the first image data to the control module 30 in step S126. Then, after receiving the instruction of the user, the control module 30 proceeds light-metering or focusing according to the first image data in step S127. Finally, after the user makes the instruction of catching images, the image-catching device 100 captures the still images according to the result of the light-metering and focusing in step S128. After completing capturing the still images, the image-catching device 100 returns back to the image-stream-exporting mode in Step S11.

In the embodiments of the disclosure, the image-catching device 100 could connect to the external device 150 via a wire, a wireless or an Internet transmission technique. For example, it could use the wire transmission such as Universal Serial Bus (USB), High-Definition Multimedia Interface (HDMI), Video transmission standard (including but not limiting to Thunderbolt), or the wireless transmission such as Wireless Fidelity (Wi-Fi), Near Field Communication (NFC) or Bluetooth, to connect the image-catching device 100 to the external device 150. Besides, whether the images from the image-catching device 100 exports to the external device 150 could be determined by the internal setting of the image-catching device 100 or the operation of an application in the external device 150. For example, whether the data is exported to the external device 150 could be determined by pressing function buttons and virtue function key on the image-catching device 100 or the external device 150, or executing an application. Besides, the image-catching device 100 could automatically detect whether the image-catching device 100 and the external device 150 are connected, and export the first image data when the image-catching device 100 and the external device 150.

Furthermore, in one embodiment, a program for executing on a device to perform the method described above could be applied according to the embodiments of the disclosure. In one more embodiment, a non-transitory storage medium for storing the program could be applied according to the embodiments of the disclosure.

According to the embodiments above, the image-catching device in the disclosure could determine that the sensor would export the images in greater pixels and frame rate or less pixels and frame rate by the fact whether the image-catching device connects to the external device, such that the image-catching device could save electricity and keep high image quality.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method of catching an image for an image-catching device having a lens and a sensor, the method comprising:
using the sensor to sense a plurality of beams passed through the lens, and converting the beams to a first image data; and
providing the first image data for an external device when the image-catching device and the external device are connected, and terminating outputting the first image data by the sensor when the image-catching device and the external device are disconnected.

2. The method according to claim 1, wherein the external device comprises a first screen, the first image data is displayed by the first screen.

3. The method according to claim 1, wherein the image-catching device further comprises a control module, and after the image-catching device and the external device are disconnected, the control module asks the sensor to convert the beams to a second image data.

4. The method according to claim 1, wherein a pixel amount of a frame of the first image data is A, a pixel amount of a frame of the second image data is B, and A is greater than B.

5. The method according to claim 3, wherein the image-catching device further comprises a second screen, and the control module asks the sensor to output the second image data to the second screen.

6. A program for executing on a device to perform the method claimed in claim 1.

7. A non-transitory storage medium for storing the program claimed in claim 6.

8. An image-catching device, comprising:
a sensor outputting a second image data in an image-stream-exporting mode; and
a control module asking the sensor to export a first image data to an external device while the image-catching device and the external device are connected;
wherein a pixel amount of a frame of the first image data is greater than a pixel amount of a frame of the second image data.

9. The image-catching device according to claim 8, wherein when the image-catching device and the external device are connected and the image-catching device is in a still-image-catching mode, the sensor outputs the second image data.

10. The image-catching device according to claim 9, further comprises a lens, the lens focuses in accordance with the second image data, and/or the sensor proceeds light-metering in accordance with the second image data.

11. The image-catching device according to claim 8, wherein the control module asks the sensor to output a third image data while the image-catching device is in a dynamic-image-catching mode.

12. An image-catching device, comprising:
a sensor; and
a control module determining whether the image-catching device connects to an external device in an image-stream-exporting mode, and asking the sensor to provide a first image data for the external device while the image-catching device and the external device are connected, otherwise asking the sensor to provide a second image data;
wherein a pixel amount of a frame of the first image data is greater than a pixel amount of a frame of the second image data.

13. The image-catching device according to claim 12, further comprises a lens, the lens focuses in accordance with the second image data, and/or the sensor proceeds light-metering in accordance with the second image data.

14. The image-catching device according to claim 12, wherein the control module asks the sensor to output a third image data while the image-catching device is in a dynamic-image-catching mode.

15. A method of exporting an image stream for an image-catching device having a sensor and a control module, the method comprising:
determining whether the image-catching device connects to an external device by the control module when the image-catching device in an image-stream-exporting mode;
providing a first image data for the external device from the sensor when the image-catching device and the external device are connected; and
outputting a second image data from the sensor when the image-catching device and the external device are disconnected;
wherein a pixel amount of a frame of the first image data is A, a pixel amount of a frame of the second image data is B, and B is not greater than A.

16. The method according to claim 15, wherein when the image-catching device and the external device are connected, the method further comprises:
using the sensor to output the second image data when the image-catching device is in a still-image-catching mode; and
proceeding light-metering or focusing according to the second image data.

17. The method according to claim 15, further comprising:
using the sensor to output a third image data while the image-catching device is in a dynamic-image-catching mode.

18. The method according to claim 15, wherein the image-catching device connects to the external device via a wire, a wireless or an Internet transmission technique.

19. A program executing on a device to perform the method claimed in claim 15.

20. A non-transitory storage medium storing the program claimed in claim 19.
